(19) United States
(12) Patent Application Publication
(10) Pub. No.: US 2024/0378010 A1
(43) Pub. Date: Nov. 14, 2024

(54) THEME SWITCH METHOD, DEVICE AND STORAGE MEDIUM

(71) Applicant: GUANGDONG OPPO MOBILE TELECOMMUNICATIONS CORP., LTD., Dongguan (CN)

(72) Inventors: Hongwei DU, Dongguan (CN); Haiyun TANG, Dongguan (CN)

(73) Assignee: GUANGDONG OPPO MOBILE TELECOMMUNICATIONS CORP., LTD., Dongguan (CN)

(21) Appl. No.: 18/776,705

(22) Filed: Jul. 18, 2024

Related U.S. Application Data
(63) Continuation-in-part of application No. PCT/CN2022/136550, filed on Dec. 5, 2022.

(30) Foreign Application Priority Data
Jan. 21, 2022 (CN) 202210070247.5

(51) Int. Cl. G06F 3/14

(52) U.S. Cl. CPC G06F 3/1454

(57) ABSTRACT

A theme switch method a device, a storage medium are provided. The method includes: a second system parsing a theme resource package, and obtaining a theme resource parsing result, wherein the theme resource parsing result includes theme resources for a first system and the second system; the second system synchronizing the theme resource to the first system based on the theme resource parsing result; the first system performing theme switch based on the synchronized theme resource; and the second system performing the theme switch based on the theme resource parsing result, wherein the theme style of the first system after the theme switch is consistent with that of the second system.

### CROSS-REFERENCE TO RELATED APPLICATIONS

This application a continuation-in-part application of International Patent Application No. PCT/CN2022/136550 filed Dec. 5, 2022, which claims a priority to Chinese Patent Application No. 202210070247.5 filed Jan. 21, 2022, the disclosures of which are incorporated herein by reference in their entireties.

### TECHNICAL FIELD

The present disclosure relates to the technical field of electronic devices, and in particular to a theme switch method, an apparatus, a device, a storage medium and a program product.

### BACKGROUND

With continuous development of science and technology, more and more electronic devices with various functions emerge, and bring plenty of convenience to user's daily life.

A user may set themes of the electronic devices according to his or her individual preference while using the electronic devices, so as to render different display effects of the electronic devices under different themes.

### SUMMARY OF THE DISCLOSURE

According to a first aspect of the present disclosure, a theme switch method is provided. The method is performed by an electronic device. The electronic device is configured to support running of a first system and a second system. The method includes: parsing, by the second system, a theme resource package, and obtaining a theme resource parsing result, wherein the theme resource parsing result includes theme resources for the first system and the second system; synchronizing, by the second system, the theme resources to the first system based on the theme resource parsing result; performing, by the first system, theme switch based on synchronized theme resources; and performing, by the second system, the theme switch based on the theme resource parsing result. After the theme switch, a theme style of the first system is the same as that of the second system.

According to a second aspect of the present disclosure, an electronic device is provided. The electronic device includes a processor and a memory, and is configured to support running of a first system and a second system. The memory is configured to store at least one instruction. The at least one instruction is configured to be executed by the processor to implement the theme switch method. The method includes: parsing, by the second system, a theme resource package, and obtaining a theme resource parsing result, wherein the theme resource parsing result includes theme resources for the first system and the second system; synchronizing, by the second system, the theme resources to the first system based on the theme resource parsing result; performing, by the first system, theme switch based on synchronized theme resources; and performing, by the second system, the theme switch based on the theme resource parsing result. After the theme switch, a theme style of the first system is the same as that of the second system.

According to a third aspect of the present disclosure, a non-transitory computer-readable storage medium is provided. The storage medium stores at least one instruction. The at least one instruction is configured to be executed by the processor to implement the theme switch method. The method is performed by an electronic device. The electronic device is configured to support running of a first system and a second system. The method includes: parsing, by the second system, a theme resource package, and obtaining a theme resource parsing result, wherein the theme resource parsing result includes theme resources for the first system and the second system; synchronizing, by the second system, the theme resources to the first system based on the theme resource parsing result; performing, by the first system, theme switch based on synchronized theme resources; and performing, by the second system, the theme switch based on the theme resource parsing result. After the theme switch, a theme style of the first system is the same as that of the second system.

### BRIEF DESCRIPTION OF THE DRAWINGS

FIG. 1 is a schematic diagram of a dual-core communication software framework corresponding to a second processor according to an exemplary embodiment of the present disclosure.

FIG. 2 is a schematic diagram of a dual-core communication software framework corresponding to a first processor according to an exemplary embodiment of the present disclosure.

FIG. 3 is a flowchart of a theme switch method according to an embodiment of the present disclosure.

FIG. 4 is a schematic diagram of the theme display styles of a first system and a second system before and after a theme switch according to an exemplary embodiment of the present disclosure.

FIG. 5 is a schematic functional diagram of a server and a device side according to an exemplary embodiment of the present application.

FIG. 6 is a flowchart of a theme switch method according to another exemplary embodiment of the present disclosure.

FIG. 7 is a flowchart of a theme switch method according to another exemplary embodiment of the present disclosure.

FIG. 8 is a schematic interface diagram illustrating a procedure of performing the theme switch via the first system according to an exemplary embodiment of the present disclosure.

FIG. 9 is a schematic interface diagram illustrating the theme deletion process according to an exemplary embodiment of the present disclosure.

FIG. 10 is a schematic interface diagram of a theme management interface according to an exemplary embodiment of the present disclosure.

FIG. 11 is a structural block diagram of a theme switch apparatus according to another embodiment of the present disclosure.

FIG. 12 is a structural block diagram of an electronic device according to an embodiment of the present disclosure.

### DETAILED DESCRIPTION

To clarify the purposes, technical solutions and advantages of the present disclosure, embodiments of the present disclosure will be described in further detail below with reference to the accompanying drawings.

The term “a plurality of” recited herein means two, or more than two. The term “and/or” is used to describe an associating relationship of associated objects, and indicates that there could be three relationships between the associated objects. For example, A and/or B may represent three situations: only A exists, A and B exist simultaneously, and only B exists. The character “/” generally indicates an “or” relationship between the associated objects before and after the character “/”.

In the related art, for an electronic device supporting dual systems, the dual systems may switch to each other in different scenarios. Take a smartwatch as an example, in a scenario of watch face display, the smartwatch may display the watch face through a first system. While in a scenario of application running, the smartwatch may run and display an application program through a second system, and realize corresponding application functions. While using the smartwatch, the user may download watch faces matching their preferences from a watch face market, and switch watch faces. However, in the case of a dual-system electronic device, if only the display style of a single system is switched, the display styles between the dual systems may be inconsistent.

In the embodiments of the present disclosure, a theme resource package including the theme resources for the first system and the second system is designed. When a theme switch is required, the second system may parse the theme resource package, synchronize the theme resources to the first system based on a theme resource parsing result, such that the second system and the first system are capable of performing synchronized theme switch based on the theme resource package. In this way, a consistency between theme styles of the first system and the second system after the theme switch is ensured.

In the embodiments of the present disclosure, a first processor and a second processor operate asynchronously, and an inter-system communication (or known as a dual-core communication) is necessary between the first system and the second system. In one possible application scenario, the first system is a real time operating system (RTOS) running on a micro controller unit (MCU), and the second system is an Android operating system running on a central processing unit (CPU).

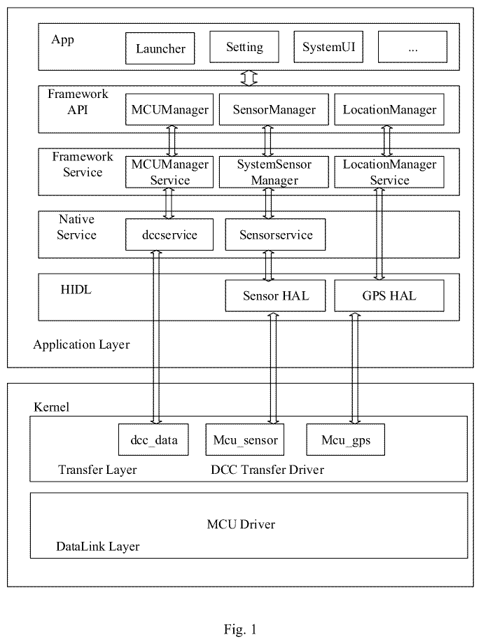

As illustrated in FIG. 1, FIG. 1 illustrates a dual-core communication software framework for the Android operating system according to an exemplary embodiment of the present disclosure. This dual-core communication software framework follows a design principle of “low coupling, high reliability, and high reuse”.

The dual-core communication software framework includes module developments of a Kernel, a hardware abstraction layer interface descriptive language (HIDL), a Native Service, a Framework Service, a Framework API and application (APP) part.

The APP module includes function modules such as a desktop Launcher or Launcher, a Setting and a System UI. The Framework API module includes management modules such as a MCU Manager, a Sensor Manager and a Location Manager. The Framework Service module includes service modules such as a MCU Manager Service, a System Sensor Manager and a Location Manager Service. The Native Service module includes service modules such as a dcc service, a Sensor service, etc. The HIDL module includes modules such as a Sensor hardware abstraction layer (Sensor HAL), a global positioning system hardware abstraction layer (GPS HAL) etc. The Kernel module includes DCC transfer drivers such as the dcc_data, the Mcu_sensor or the Mcu_gps etc.

The transport layer, as an interface layer for connecting upper layers and lower layers in the dual-core communication software framework, is configured to shield the transmission details of communication of the lower layers (the data link layer) of the system for the application layer, and provide service channels for the application scenarios. The application layer, as a principal service provider, is configured to: respond to human-computer interactions; transmit data generated during human-computer interactions through the transport layer; and respond to external data requests.

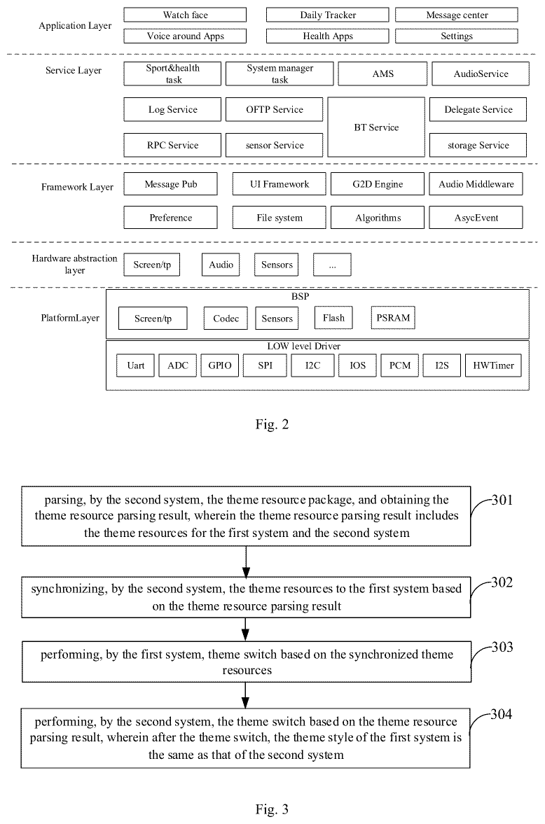

The RTOS is designed according to a principle of equivalence. A case where the electronic device is a smartwatch is taken as an example. As illustrated in FIG. 2, FIG. 2 illustrates the dual-core communication software framework for the RTOS according to an exemplary embodiment of the present disclosure.

The dual-core communication software framework of the RTOS is divided into an application layer, a service layer, a framework layer, a hardware abstraction layer and a platform layer.

The application layer may include application modules such as a watch face, a daily tracker, a message center, voice around Apps, health Apps or settings etc. The service layer may include service modules such as a Sport&health task, a system manager task, an activity management service (AMS), an audio service, a log service, an Odette file transfer protocol (OFTP) Service, a Bluetooth (BT) Service, a delegate service, a remote procedure call (RPC) service, a sensor service, a storage service etc. The framework layer includes frame modules such as a message pub, a user interface (UI) framework, a G2D Engine, an audio middleware, a preference, a file system, an algorithms, Asyc events (in-process asynchronous events) etc. The hardware abstraction layer includes hardware abstraction modules such as a screen/touch panel (TP), sensors etc. The platform layer includes a board support package (BSP) and a low level driver. The BSP includes a screen/TP, a codec, a sensor, a Flash, a pseudo static random memory (PSRAM) etc. The low level drivers include a Uart (universal asynchronous receiver/transmitter), an analog-to-digital converter (ADC), a general purpose input/output (GPIO), a serial peripheral interface (SPI), an inter-integrated circuit (I2C), an input/output system (IOS), a pulse coded modulation (PCM), an integrated interchip sound (I2S), a Hardware timer (HWTimer).

The above-mentioned dual-core communication software framework is for schematic illustration only. Those of ordinary skills in the art may also add, remove or modify the above-mentioned frame as per the actual needs. The specific structural constitution of the dual-core communication software framework is not limited in embodiments of the present disclosure.

As illustrated in FIG. 3, FIG. 3 is a flowchart of a theme switch method according to an embodiment of the present disclosure. In some embodiments, an example is illustrated in which the method is applied to the electronic device, and the electronic device is configured to support running or operation of the first system and the second system. The method may include operations at blocks illustrated in FIG. 3.

At block 301: parsing, by the second system, a theme resource package, and obtaining a theme resource parsing result. The theme resource parsing result includes theme resources for the first system and the second system.

To reduce power consumption of the electronic device while ensuring a performance of the electronic device, in some embodiments, the electronic device is provided with at least a first processor and a second processor. A processing performance and the power consumption of the first processor and the second processor are different from each other. The first processor is configured to run the first system, the second system is configured to run the second system, and a dual-core dual-system is thus formed. A system switching mechanism for the dual-core dual-system is designed.

During operation of the electronic device, events with low performance processing requirements are processed by a low-power-consumption system running on a low-power-consumption processor, and the high-power-consumption processor is kept in a sleep state or dormant state. The low-power-consumption system may be the first system or the second system. Accordingly, a high-power-consumption system running by the high-power-consumption processor is in the sleep state. In this way, the power consumption of the electronic device is reduced while fulfilling basic functions of the electronic device. When there is an event with high performance processing requirements, the event is processed by awaking the high-power-consumption processor and switching to the high-power-consumption system. In this way, timely response and processing of the triggered event will be ensured, thereby satisfying the performance requirements of the electronic device.

In some embodiments, the electronic device is provided with the first processor and the second processor. The processing performance of the first processor is inferior to that of the second processor. The processing capability and processing speed of the first processor are both lower than those of the second processor. The power-consumption of the first processor is lower than that of the second processor. Accordingly, the second system (operated by the second processor) is capable of processing events processed by the first system operated by the first processor, while the first system is not necessarily capable of processing events processed by the second system. Of course, the first system may also be run by the second processor, and the second system may also be run by the first processor, which is not limited in the present embodiment.

In some embodiments, the electronic device may also be provided with a single processor, and the first system and the second system are configured to run on separate cores of the single processor. The processing performance of the core running the second system is superior to the processing performance of another core running the first system.

For example, a case where the electronic device is a smartwatch is taken as an example. The first processor is an MCU, and the second processor is a CPU. The first system is a RTOS, and the second system is an Android system. Accordingly, the events that can be handled by the first system include scenarios that require low processing performance or weak interaction scenarios, such as a watch face display, a watch face interface switch, a display of notification messages etc. The events that can be handled by the second system include scenarios that require higher processing performance or strong interaction scenarios, such as a call answer, a message reply, a function setting, etc.

The watch faces described in various embodiments of the present application are not physical watch faces, but virtual watch faces. A physical watch face consists, for example, of a physical pointer and a physical watch face scale. A virtual watch face is presented on a screen via an image rendering display technique. Accordingly, a watch face switch process is a watch face image updating process. Furthermore, in some embodiments of the present disclosure, in addition for displaying the time, the watch face may also be configured to display other information, such as movement conditions, a device power level, weather conditions, widgets, etc. The watch face may also be designed to present different visual effects, which is not limited in embodiments of the present disclosure.

In some embodiments of the present disclosure, the theme resource package is configured to update themes of the first system and the second system of the electronic device. Therefore, the theme resource parsing result, which is obtained from parsing the theme resource package by the second system, includes the theme resources of both the first system and the second system.

In some embodiments, the theme resources include theme resource files and theme configuration information. The types of the theme resource files may include pictures, audios, videos, texts etc. The theme configuration information is configured to configure parameters of a theme display process. For example, the theme configuration information includes interface background colors, font sizes, font colors etc.

Regarding sources of the theme resource package, in some embodiments, the theme resource package may be downloaded by the second system from a server. For example, the second system downloads the theme resource package from the server via a theme market App. In some embodiments, the theme resource package may be transmitted to the electronic device from other devices. For example, the theme resource package may be transmitted to the electronic device via a Bluetooth connection. The sources of the theme resource package are not limited in embodiments of the present disclosure.

In some embodiments, the parsing process of the second system on the theme resource package may include resource package integrity checking, resource package decompression and file parsing etc., which is not limited in the present embodiment.

At block 302: synchronizing, by the second system, the theme resources to the first system based on the theme resource parsing result.

To ensure a consistency between themes of dual systems after the theme switch, the second system may synchronize the theme resources to the first system based on the theme resource parsing result, and instruct the first system to perform the theme switch based on synchronized theme resources. The second system may instruct the first system by sending a theme switch instruction to the first system.

In some embodiments, the second system synchronizes the theme resources to the first system through a dual-core communication approach. When the first system is in a sleep state, the second system would need to awake the first system first. For example, the second system may awake the first system by generating an interrupt. which is not limited in the present embodiment.

In some embodiments, the second system may synchronize all the theme resource parsing result to the first system, or, the second system may synchronize a portion of the theme resource parsing result to the first system. The portion of the theme resource parsing result may at least satisfy the theme switch requirements of the first system.

At block 303: performing, by the first system, theme switch based on the synchronized theme resources.

In some embodiments, in response to the second system synchronizing all the theme resource parsing result or the whole theme resource parsing result to the first system, the first system determines desired theme resources from the whole theme resource parsing result and performs the theme switch. In some embodiments, in response to the second system synchronizing a portion of the theme resource parsing result to the first system, the first system performs the theme switch based on the portion of the theme resource parsing result.

In some embodiments, the theme resources corresponding to different themes are stored in a storage space corresponding to the first system. The first system stores the theme resources obtained by synchronization process to the storage space, so that a subsequent theme switch can be performed based on the theme resources in the storage space.

At block 304: performing, by the second system, the theme switch based on the theme resource parsing result. After the theme switch, the theme style of the first system is the same as that of the second system.

In some embodiments, the second system determines, from the theme resource parsing result, the theme resources required for its own theme switch and performs the theme switch. There are no strict temporal relationships between the respective theme switch processes of the first system and the second system. In other words, the first system and the second system may synchronize their theme switch processes, or the first system and the second system may successively perform their theme switch processes, which is not limited in the present embodiment. An interval between their theme switches is so short that the user is unlikely to perceive it.

In some embodiments, the theme resources corresponding to different themes are stored in a storage space corresponding to the second system. The second system stores the theme resources used in the theme switch process to the storage space, so that the subsequent theme switch may be performed based on the theme resources in the storage space.

Since the theme switches of the first system and the second system are respectively performed based on the parsing result of the same theme resource package, thus after the theme switches, the theme style of the first system is kept consistent with that of the second system. The theme style includes, but is not limited to, fonts, font sizes, background colors, font colors, icons etc.

In some embodiments, the consistency between theme styles may include at least one situation selected from a group consisting of the following 3 situations.
Situation 1: the background of the first system is consistent with that of the second system, or the background style of the first system is consistent with that of the second system. The background includes background colors, background patterns, background videos, etc. The background style includes solid color styles, cartoon styles, portrait styles, landscape styles, etc.
Situation 2: at least one selected from a group consisting of the fonts, the font sizes, the font colors and the font boldness of the first system is consistent with that of the second system.
Situation 3: the icons of the first system are consistent with that of the second system. In some embodiments, the icon styles of the first system are consistent with those of the second system, and the icon styles include flattened styles, skeuomorphic styles, cartoon styles, realistic styles etc. In some embodiments, at least one of the icon size and the icon profile is consistent between the first system and the second system. The icon profile is, for example, a rectangular icon, a circular icon, a rounded-corner rectangular icon etc.

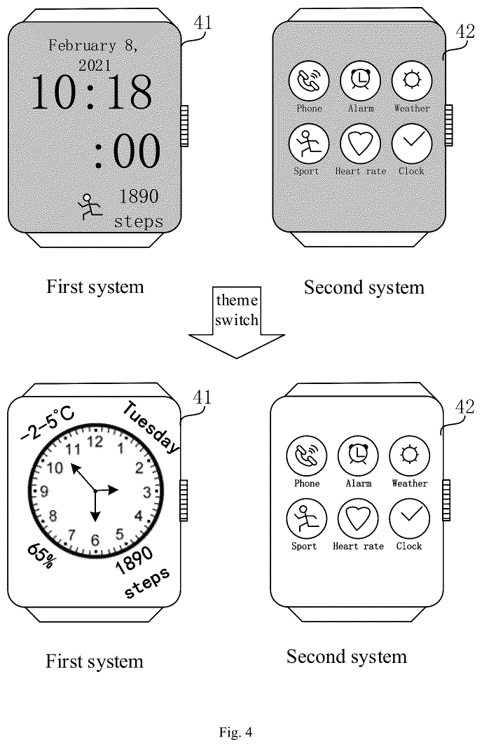

Of course, in addition to the above elements, any other elements that would impact on perceived consistency could be considered as theme style consistency elements, which is not limited in embodiments of the present disclosure. In an exemplary example, as illustrated in FIG. 4, the smartwatch supports the running of the first system and the second system. The theme style of a watch face interface 41 currently displayed by the first system includes regular script fonts and a gray background color, and the theme style of the application list interface 42 currently displayed by the second system also includes regular script fonts and the gray background. When the theme switch is performed, both the watch face interface 41 and the application list interface 42 undergo the theme switch, and the theme styles of both the watch face interface 41 and the application list interface 42 after the theme switch include bold-face fonts and white background colors. In this way, a situation may be avoided where the fonts and/or the background colors of the dual systems are inconsistent when the theme switch is performed only on a single system of the dual systems.

In summary, in the embodiments of the present disclosure, for the electronic device supporting the dual systems, the theme resource package is parsed by the second system, and the theme resource parsing result including the theme resources of both the first system and the second system are obtained. The second system may further synchronize the theme resources to the first system based on the theme resource parsing result, so as to keep the theme switch between the first system and the second system synchronized. In this way, the consistency between the theme styles of the dual systems after the theme switch is ensured, thereby avoiding a problem of inconsistency between the theme styles of dual systems due to merely switching the theme of a single system.

In some embodiments, the theme resource parsing result includes first theme resources and second theme resources. The first theme resources include the theme resources required for the first system to perform the theme switch. The second theme resources include the theme resources required for the second system to perform the theme switch.

The step of synchronizing, by the second system, the theme resources to the first system based on the theme resource parsing result may include: synchronizing, by the second system, the first theme resources to the first system.

The step of performing, by the second system, the theme switch based on the theme resource parsing result may include: performing, by the second system, the theme switch based on the second theme resources.

In some embodiments, the theme resource parsing result includes first resources, second resources, and shared resource. The first resources are theme resources unique for the first system. The second resources are theme resources unique for the second system. The shared resources are theme resources shared by the first system and the second system.

The first theme resources include the first resources and the shared resources. The second theme resources include the second resources and the shared resources.

In some embodiments, the shared resources include shared resource files and shared configuration information. The shared resource files include at least one of shared font files and shared icons. The shared configuration information includes at least one of font sizes, font colors, and background colors.

In some embodiments, the first system is configured to display a watch face interface, and the second system is configured to display another user interface other than the watch face interface.

The first theme resources include the resource files and configuration information corresponding to the watch face interface.

The second theme resources include the resource files and configuration information corresponding to the another user interface.

In some embodiments, the step of performing, by the second system, the theme switch based on the theme resource parsing result may include: in response to receiving a successful message of synchronization sent from the first system, performing, by the second system, the theme switch based on the theme resource parsing result. The method further includes: in response to receiving a failed message of synchronization sent from the first system, or, in response to no reception of a feedback message of a synchronization result sent from the first system within a target time period, terminating, by the second system, the theme switch.

In some embodiments, the system power consumption of the second system is greater than that of the first system. The method further includes: displaying, by the second system, a theme preview interface; and, in response to a triggering operation on a theme switch control in the theme preview interface, downloading, by the second system, the theme resource package from the server.

In some embodiments, the system power consumption of the second system is less than that of the first system. The electronic device establishes a data connection with an external device through the second system. The method further includes: receiving, by the second system, the theme resource package transmitted from the external device; and, in response to the first system being in the sleep state, awaking, by the second system, the first system.

In some embodiments, the method further includes: in response to a theme switch operation, sending, by the first system, the theme switch instruction to the second system; performing, by the second system, the theme switch based on the theme switch instruction; and, performing, by the first system, the theme switch based on the theme switch operation. After the theme switch, the theme style of the first system is the same as that of the second system.

In some embodiments, the theme switch instruction includes a target theme identifier for representing a target theme. The first system and the second system store the correspondence relation between theme identifiers and the theme resources. The step of performing, by the second system, the theme switch based on the theme switch instruction may include: obtaining, by the second system, a second target theme resource corresponding to the target theme based on the target theme identifier, wherein the second target theme resource includes the theme resources required for the second system to switch to and display the target theme; switching, by the second system, a current theme to the target theme based on the second target theme resource. The step of performing, by the first system, the theme switch based on the theme switch operation may include: obtaining, by the first system, a first target theme resource corresponding to the target theme, wherein the first target theme resource includes the theme resources required for the second system to switch to and display the target theme; and, switching, by the first system, the current theme to the target theme based on the first target theme resource.

In some embodiments, an interface displayed by the first system includes the watch face interface.

The step of sending by the first system the theme switch instruction to the second system in response to the theme switch operation includes: in response to a sliding operation for switching on the watch face, sending, by the first system, the theme switch instruction to the second system, wherein the sliding operation for switching is configured to switch the watch face interface.

In some embodiments, the method further includes: in response to a first theme deletion operation, deleting, by the first system, a theme resource and sending a theme deletion instruction to the second system; and, deleting, by the second system, the theme resource based on the theme deletion instruction. In some embodiments, the method further includes: in response to a second theme deletion operation, deleting, by the second system, the theme resource and sending the theme deletion instruction to the first system; and, deleting, by the first system, the theme resource based on the theme deletion instruction.

In some embodiments, prior to parsing the theme resource package by the second system, the second system is configured to display the theme preview interface. This theme preview interface is configured to demonstrate an effect of the theme. In some embodiments, the second system is one system of the dual systems that consumes more power to run than another system of the dual systems. The second system includes a theme market App. The theme market App displays the theme preview interface during operation.

In response to the triggering operation on the theme switch control in the theme preview interface, downloading, by the second system, the theme resource package from the server. This theme resource package is the resource package corresponding to a current preview theme in the theme preview interface. This server is the back-end server of the theme market App, and stores theme resource packages corresponding to different themes.

In some embodiments, the second system is required to authenticate its identity with the server first prior to downloading the theme resource package from the server, and may download the theme resource package after authentication has been passed. Further, after the theme resource packages has been downloaded, the second system is required to verify or check the theme resource package and execute the parsing process after the verification has passed.

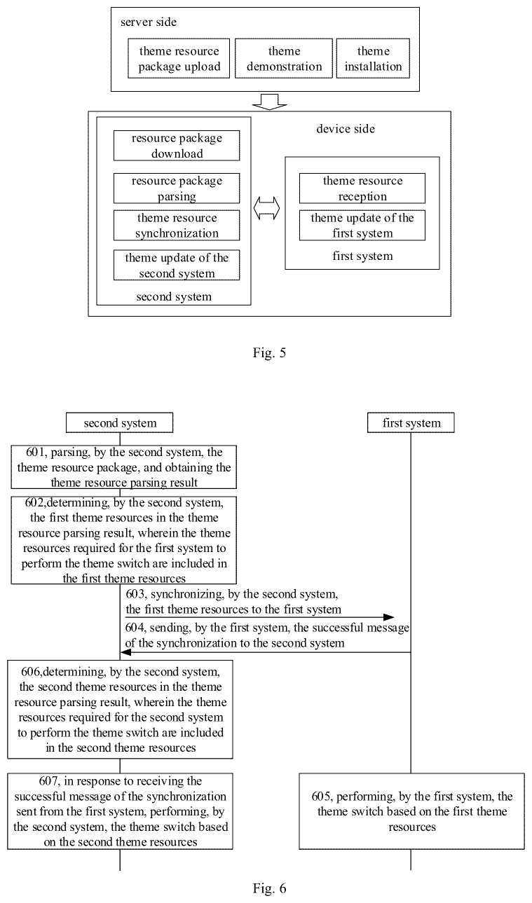

As an example, as illustrated in FIG. 5, in the above-mentioned scenario, an implementation of the theme switch function may be divided into a server side and a device side. The server side may be divided into three parts: the theme resource package upload module, the theme demonstration module, and the theme installation module. The second system of the device side may include four parts: the resource package download module, the resource package parsing module, the theme resource synchronization module and the theme update module of the second system. The first system of the device side may include two parts: the theme resource reception module and the theme update module of the first system.

The theme resource package upload module is responsible for uploading the theme resource package developed by a developer, and for checking the theme resource package. The theme resource package that has passed the check may be uploaded to the theme market for the users to select and download. The theme demonstration module provides a theme demonstration function, which enables the users to preview the display effects of different themes, so as to select the themes that satisfies the users' needs and download them. The theme installation module is responsible for transmitting the theme resource package of the selected theme to the device, so that the device may subsequently perform parsing and installation.

The resource package download module at the second system side is configured to download the theme resource package from the server side, and to verify the downloaded theme resource package. The resource package parsing module is configured to parse the theme resource package that has passed the verification, and obtain the theme resource parsing result. The theme resource synchronization module is configured to synchronize the theme resources to the first system, and obtain the synchronization result. The theme update module of the second system is configured to update the theme of the second system based on the theme resource parsing result.

The theme resource reception module at the first system side is configured to receive the theme resources synchronized by the second system, and feedback the synchronization result to the second system. The theme update module of the first system is configured to update the theme of the first system based on the synchronized theme resources.

In some embodiments, an operating power consumption of the second system is less than that of the first system. To reduce the power consumption of the electronic device, the electronic device establishes the data connection with the external device through the second system. The second system remains awake during operation of the electronic device, while the first system is sleep for most of the time. When the second system receives the theme resource package transmitted from the external device, in order to avoid unnecessary data transmission, the theme resource package may be parsed by the second system and the theme resource parsing result may be obtained. A case of unnecessary data transmission may be a case, where the theme resource package is transmitted to the first system, the first system then parses the theme resource package and synchronizes the theme resources to the second system. In response to the first system being in the sleep state, the second system first awakes the first system, thereby synchronizing the theme resources to the first system in the awakened state, so that the first system may perform the theme switch.

In order to avoid transmission of unnecessary data to the first system during the theme resource synchronization process, in some embodiments, prior to synchronizing the theme resources to the first system by the second system, the second system should first determine the portion of theme resources required by the first system for the theme switch, and synchronize this portion of the theme resources to the first system, rather than synchronizing the whole theme resource parsing result to the first system. In this way, data volume of the synchronization process may be reduced. Some exemplary embodiments are adopted for illustration below.

As illustrated in FIG. 6, FIG. 6 is a flowchart of the theme switch method according to another exemplary embodiment of the present disclosure. In this embodiment, as an example, the method is applied to the electronic device, and the electronic device is configured to support the running of the first system and the second system. The method may include operations at blocks illustrated in FIG. 6.

At block 601: parsing, by the second system, the theme resource package, and obtaining the theme resource parsing result. The theme resource parsing result includes the theme resources for the first system and the second system.

The implementation of this step may be referred to the above-mentioned block 301, and would not be elaborated herein in the present embodiment.

At block 602: determining, by the second system, the first theme resources in the theme resource parsing result. The first theme resources include the theme resources required for the first system to perform the theme switch.

Since the theme resource parsing result is a collection of resources required for the first system and the second system to perform the theme switch, and the first system may not need to use all contents of the theme resource parsing result when performing the theme switch, therefore, the second system is required to determine, from the theme resource parsing result, the first theme resources required for the first system to perform the theme switch.

Regarding an approach of determining the first theme resources, in some embodiments, the theme resource parsing result includes first resources, second resources and shared resources. The first resources are theme resources unique for the first system. That is, during the theme switch process, the first resources are required only by the first system, and are not required by the second system. The second resources are theme resources unique for the second system. That is, during the theme switch process, the second resources are required only by the second system, and are not required by the first system.

In some embodiments, the shared resources include the shared resource files and the shared configuration information. Since both the first system and the second system need to display texts as well as backgrounds, and there is an intersection between the icons displayed by the first system and the second system. Therefore, in order to ensure the consistency of displayed texts and backgrounds of the dual systems, the shared resource files may include at least one of shared font files and shared icons, and the shared configuration information may include at least one of font sizes, font colors, and background colors.

In an exemplary example, the first system is configured to display a watch face interface, and the second system is configured to display an application list interface. The first resources include the watch face resources. The watch face resources may include background images of the watch faces, layouts and positions of the widgets on the watch faces, etc. The second resources include application icon resources. The application icon resources may for example be icon images, icon layout information, icon size information, etc. The shared resources include font resources and background colors. The font resources may for example be font files, font sizes, and font colors. Specific resource types of the first resources, the second resources, and the shared resources are not limited in embodiments of the present disclosure.

In some embodiments, the second system may obtain the first resources and the shared resources included in the theme resource parsing result, and determine the first resources and the shared resources as the first theme resources. The first theme resources are resource collections of the first resources and the shared resources.

At block 603: synchronizing, by the second system, the first theme resources to the first system.

Further, the second system synchronizes only the first theme resources to the first system. In comparison with synchronizing the whole theme resource parsing result to the first system, synchronizing only the first theme resources may, on the premise of ensuring subsequent normal switching of themes of the first system, reduce synchronized data volume.

At block 604: sending, by the first system, the successful message of synchronization to the second system.

In order to avoid a case where the synchronization fails, the second system is able to perform theme switch normally while the first system is unable to do so, thereby resulting in inconsistency between the theme styles of the dual systems, in some embodiments of the present disclosure, the first system is required to provide feedback to the second system based on the synchronization situation of the theme resources.

In response to a successful synchronization of the first theme resources, sending, by the first system, the successful message of synchronization to the second system. In response to a failed synchronization of the first theme resources, sending, by the first system, the failed message of synchronization to the second system.

In some embodiments, after receiving the synchronized theme resources from the second system, the first system may perform an integrity check on the received theme resources. When the integrity check is passed, the first system may send a successful message of synchronization to the second system. If the integrity check is not passed, the first system would send a failed message of synchronization to the second system.

If there is an abnormality in a communication link between the first system and the second system, the first system is unable to receive the synchronized theme resources, and would not provide feedback about the synchronization results. In this case, the second system would not receive the successful message of synchronization or the failed message of synchronization.

At block 605: performing, by the first system, the theme switch based on the first theme resources.

In response to successful synchronization of the first theme resources, the first system performs the theme switch based on the first theme resources.

In some embodiments, the first system may store the first theme resources into the storage space for use in subsequent theme switch.

At block 606: determining, by the second system, the second theme resources in the theme resource parsing result. The second theme resources include the theme resources required for the second system to perform the theme switch.

Since the second system may not need to use all contents of the theme resource parsing result when performing the theme switch, therefore, the second system is required to determine, from the theme resource parsing result, the theme resources required for itself to perform the theme switch. Therefore, the second system may subsequently perform the theme switch based on the second theme resources.

In some embodiments, the second system may obtain the second resources and the shared resources included in the theme resource parsing result, and determine the second resources and the shared resources as the second theme resource. The second theme resources are resource collections of the second resources and the shared resources.

In some embodiments, the first theme resources and the second theme resources may also be added to the theme resource package to be parsed in the form of resource data packages. The second system may determine, based on the identifiers corresponding to the resource data packages in the parsing result, the system corresponding to each resource data package. In comparison with providing shared resources, directly providing the first theme resources and the second theme resources would result in data redundancy. Both the first theme resources and the second theme resources include the shared resources.

At block 607: in response to receiving a successful message of synchronization sent from the first system, performing, by the second system, the theme switch based on the second theme resource.

The second system would perform the theme switch based on the second theme resources only in response to receiving the successful message of synchronization sent from the first system.

In some embodiments, in response to receiving the failed message of synchronization sent from the first system, or in response to no reception of the feedback message of the synchronization result sent from the first system within the target time period, terminating, by the second system, the theme switch. The no reception of the feedback message may possibly be due to an abnormal inter-system communication link. In this way, the inconsistency between the theme styles of the dual systems after the theme switch may be avoided. This target time period may for example be 1000 ms.

In some embodiments, the second system may store the second theme resources into the storage space for use in the subsequent theme switch.

In an exemplary example, when the electronic device is the smartwatch, the first system is configured to display a watch face interface, and the second system is configured to display the another user interface other than the watch face interface. The first theme resources include the resource files and configuration information corresponding to the watch face interface. The second theme resources include the resource files and configuration information corresponding to the another user interface.

When performing the theme switch, the first system may update the watch face interface based on the resource files and the configuration information corresponding to the watch face, including updating the layout modes of the widgets, the background colors, the data update modes, etc. of the watch face interface. The resource files include the watch face background image resources, the font files. The configuration information includes the date-and-time display format of the watch face interface, the font sizes of the watch face interface, and the font colors.

The second system may update the another user interface other than the watch face interface based on the configuration information. The configuration information is for example the background colors, the font files, the font sizes, the font colors etc. The another user interface is, for example, status bar interfaces, notification message interfaces, activity card interfaces etc. The second system may update the application list interface based on the application icons (of the resource files), the background colors, the font files, the font sizes, and the font colors (of the configuration information).

In some other examples, when the electronic device is the smartwatch, the first system is configured to display a watch face interface, and the second system is configured to display a watch face interface and the another user interface other than the watch face interface. The first theme resources include the resource files and configuration information corresponding to the watch face interface. The second theme resources include the resource files and configuration information corresponding to the watch face interface and the another user interface.

In the present embodiment, the second system determines, from the parsing result, the first theme resources required for the first system to perform the theme switch, and synchronizes the first theme resources to the second system. In this way, a normal theme switch of the first system may be ensured, and the data volume of synchronization may be reduced.

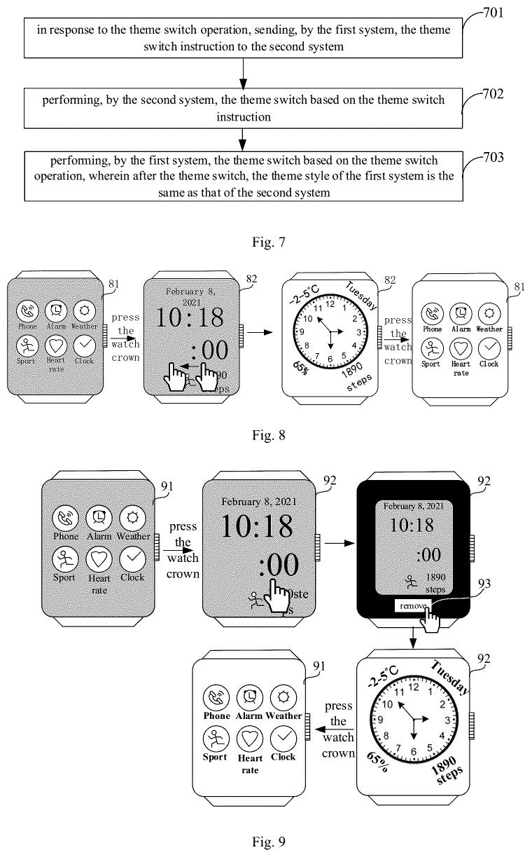

In addition to the requirement of the theme switch when anew theme resource package is obtained, in some possible application scenarios, the user may trigger, through a theme switch operation, the system that is currently running at the front-end, and perform the theme switch. For example, the user may switch, by a sliding operation for switching on the watch face interface, the theme of the first system, i.e., the watch face interface switch. In order to ensure the consistency between theme styles of the systems in this scenario, the method may further include operations at blocks illustrated in FIG. 7.

At block 701: in response to the theme switch operation, sending, by the first system, the theme switch instruction to the second system.

In some embodiments, the theme switch operation may be a touch operation (e.g., a swiping operation), a voice-triggered operation, a gesture operation (e.g., shaking of the electronic device), a key-pressing operation (e.g., pressing of a physical button), etc., which is not limited in the present embodiment.

In some embodiments, when an interface displayed by the first system includes the watch face interface, in response to the sliding operation for switching on the watch face, the first system may send the theme switch instruction to the second system. This sliding operation for switching is configured to switch the watch face interface.

In order to explicitly indicate the theme to be switched by the second system, the theme switch instruction sent by the first system may include a target theme identifier of the target theme to be switched. This target theme is determined and obtained based on the theme switch operation.

A case is illustrated as an example, where the electronic device is the smartwatch, the first system is configured to display a watch face interface, and the second system is configured to display the another user interface other than the watch face interface. In response to receiving the sliding operation for switching within the watch face interface, the first system determines that the theme switch operation has been received, and determines, based on a sliding direction of the sliding operation for switching, the target theme.

In response to the second system being in the sleep state, the first system needs to first awake the second system, and then send the theme switch instruction to the second system.

At block 702: performing, by the second system, the theme switch based on the theme switch instruction.

The second system determines the target theme to be switched based on the theme switch instruction, thereby switching the current theme to the target theme.

In some embodiments, the second system stores the correspondence relation between the theme identifiers and the theme resources. The second system obtains, based on the target theme identifier included in the theme switch instruction, the second target theme resource corresponding to the target theme. The second system further switches, based on the second target theme resource, the current theme to the target theme. The second target theme resource includes theme resources required for the second system to switch to and display the target theme. As an example, the correspondence relation between the theme identifiers and the theme resources in the second system is illustrated in Table I.

TABLE I

| theme identifier | theme resource |
|---|---|
| Theme1 | theme resource A2 |
| Theme2 | theme resource B2 |
| Theme3 | theme resource C2 |

For example, in response to the target theme identifier being the Theme2, the second system may obtain the theme resource B2, and perform the theme switch based on the theme resource B2.

At block 703: performing, by the first system, the theme switch based on the theme switch operation. After the theme switch, the theme style of the first system is the same as that of the second system.

In some embodiments, the first system stores the correspondence relation between the theme identifiers and the theme resources. The first system may obtain the first target theme resource corresponding to the target theme, and switch, based on the first target theme resource, the current theme to the target theme. The first target theme resource includes theme resources required for the first system to switch to and display the target theme.

As an example, the correspondence relation between the theme identifiers and the theme resources in the first system is illustrated in Table II.

TABLE II

| theme identifier | theme resource |
|---|---|
| Theme1 | theme resource A1 |
| Theme2 | theme resource B1 |
| Theme3 | theme resource C1 |

For example, in response to the target theme identifier being the Theme2, the first system may obtain the theme resource B1 and perform the theme switch based on the theme resource B1.

Since the first target theme resource and the second target theme resource both belong to the theme resource package corresponding to the same theme, therefore, after the theme switch, the theme style of the first system is consistent with that of the second system.

In some embodiments, in response to the theme switch operation being the sliding operation for switching on the watch face interface of the first system, the first system switches, based on the sliding operation for switching, the watch face interface. The second system performs, based on the received theme switch instruction, the theme switch. In this way, it is ensured that, the switched theme style of the second system is consistent with the switched style of the watch face interface.

In some possible cases, if there is an abnormality in the data link between the first system and the second system, the second system may not be able to receive the theme switch instruction. Therefore, for the sake of the consistency of the system theme switch, in response to receiving the theme switch instruction, the second system would send a switch response to the first system. In response to receiving the switch response, the first system may perform the theme switch, and in response to not receiving the switch response, the first system may terminate the theme switch.

In an exemplary example, as illustrated in FIG. 8, the first system and the second system are configured to run on the smartwatch. The application list interface 81 currently displayed in the second system adopts the theme 1. The theme 1 includes a gray background and regular script letters. In response to receiving a pressing operation on a watch crown, the first system may switch to a front-end operation state, i.e., the first system acquires a control authority of the screen, and the currently displayed watch face interface 82 likewise adopts the theme 1. In response to a sliding operation performed by the user on the watch face interface 82 for switching the watch face, the first system may switch, based on the sliding direction of the sliding operation, the watch face interface 82. The switched watch face interface adopts the theme 2. The theme 2 includes a white background and bolded letters. In response to receiving the sliding operation, the first system sends the theme switch instruction to the second system, and instructs the second system to switch the theme from the theme 1 to the theme 2. After the watch face switch has been completed, in response to receiving the pressing operation on the watch crown, the second system may switch to the front-end operation state, i.e., the second system acquires the control authority of the screen. At this time, the application list interface 81 displayed by the second system also adopts the theme 2.

In some embodiments, in response to receiving the theme switch operation, the first system instructs, by sending the theme switch instruction to the second system, the second system to synchronously perform the theme switch. In this way, the consistency of the theme styles of the dual-systems is ensured. Therefore, for electronic devices such as smartwatches etc., it is possible to achieve a case in which the themes of another user interfaces may be synchronously switched while the watch face interface is switched. In this way, the style of the watch face interface is consistent with that of the another user interfaces.

During daily use, in addition to adding new themes to his/her electronic device, the user may also delete an existing theme. Since there are theme resources stored in each of the storage spaces corresponding to the first system and the second system respectively, when performing theme deletion processes, the first system and the second system are likewise required to keep in synchronization.

In some embodiments, in response to a first theme deletion operation: deleting, by the first system, the theme resource and sending a theme deletion instruction to the second system; and deleting, by the second system, the theme resource based on the theme deletion instruction.

In some embodiments, the correspondence relation between the theme identifiers and the theme resources is stored in the storage space corresponding to the first system. In response to receiving a theme deletion operation acting on the first system, the first system may delete, from the storage space, the theme resource corresponding to the theme to be deleted. The first system sends the theme deletion instruction to the second system. The theme deletion instruction includes a theme identifier corresponding to the theme to be deleted. The second system determines, based on the theme identifier included in the theme deletion instruction, a theme resource in the storage space corresponding to the theme identifier, and deletes the theme resource.

In some embodiments, in response to the second system being in the sleep state, the first system first awakes the second system, and then sends the theme deletion instruction to the second system. In some embodiments, in response to the second system being in an awakened state, the first system sends the theme deletion instruction to the second system (not real-time awakening of the second system), to avoid frequent awakening of the second system.

In some embodiments, in response to the theme to be deleted being the current theme, the first system is further required to determine and obtain the theme to be switched. The first system further sends the theme switch instruction to the second system, and instructs the second system to perform the theme switch.

In an exemplary example, as illustrated in FIG. 9, the first system and the second system are configured to run on the smartwatch. The application list interface 91 currently displayed in the second system adopts the theme 1. The theme 1 includes the gray background and regular script letters. In response to receiving a pressing operation on the watch crown, the first system switches to the front-end operation state, i.e., the first system acquires the control authority of the screen, and the currently displayed watch face interface 92 likewise adopts the theme 1. In response to a press-and-hold operation by the user on the watch face interface 92, the first system displays a watch face deletion control 93. In response to the user clicking on the watch face deletion control 93, the first system determines that the current watch face needs to be deleted and another watch face needs to be displayed, thereby sending the theme deletion instruction and the theme switch instruction to the second system. In response to receiving the theme deletion instruction and the theme switch instruction, the second system deletes the theme 1 and switches to the theme 2.

At the same time, the first system switches the watch face interface 92, and the switched watch face interface adopts the theme 2. The theme 2 includes a white background and bold-face letters. After the watch face switch has been completed, in response to receiving the pressing operation on the watch crown, the second system switches to the front-end operation state, i.e., the second system acquires the control authority of the screen. At this time, the application list interface 91 displayed by the second system also adopts the theme 2.

In some embodiments, in response to the second theme deletion operation: deleting, by the second system, the theme resource and sending the theme deletion instruction to the first system; and, deleting, by the first system, the theme resource based on the theme deletion instruction.

In some embodiments, unlike the first theme deletion operation, the second theme deletion operation is triggered in the second system. For example, the second system displays a theme list in a theme management interface. The theme list includes the installed themes. In response to receiving a click operation on a deletion control corresponding to a theme, the second system determines that a theme deletion operation is received.

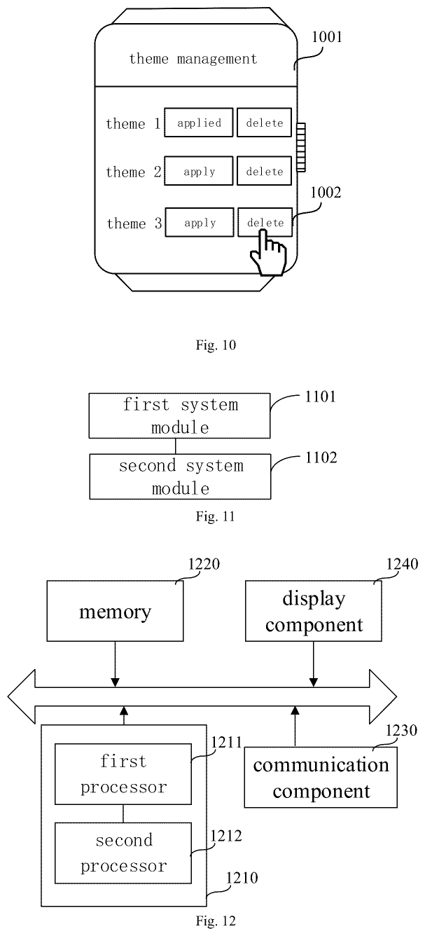

As an example, as illustrated in FIG. 10, the various themes that have been installed are displayed in a theme management interface 1001 of the second system. The various installed themes correspond to theme application controls and deletion controls 1002 respectively. In response to receiving the click operation on the deletion control 1002 corresponding to a theme 3, the second system deletes the theme resource corresponding to the theme 3 from its own storage space. The second system further instructs, by sending the theme deletion instruction, the first system to delete the theme resource corresponding to the theme 3 in its own storage space.

As illustrated in FIG. 11, FIG. 11 is a structural block diagram of a theme switch apparatus according to an embodiment of the present disclosure. This apparatus may be implemented as a whole or a part of the electronic device through software, hardware, or a combination of both. The apparatus includes a first system module 1101 and a second system module 1102. The second system module 1102 is configured to parse the theme resource package, and obtain the theme resource parsing result. The theme resource parsing result includes the theme resources for the first system and the second system. The second system module 1102 is further configured to synchronize the theme resources to the first system module 1101 based on the theme resource parsing result. The first system module 1101 is configured to perform the theme switch based on the synchronized theme resources. The second system module 1102 is further configured to perform the theme switch based on the theme resource parsing result. After the theme switch, the theme style of the first system is the same as that of the second system.

In some embodiments, the theme resource parsing result includes first theme resources and second theme resources. The first theme resources include the theme resources required for the first system to perform the theme switch. The second theme resources include the theme resources required for the second system to perform the theme switch. The second system module 1102 is configured to synchronize the first theme resources to the first system module 1101. The second system module 1102 is further configured to perform the theme switch based on the second theme resources.

In some embodiments, the theme resource parsing result includes first resources, second resources, and shared resource. The first resources are theme resources unique for the first system. The second resources are theme resource unique for the second system. The shared resources are theme resource shared by the first system and the second system. The first theme resources include the first resources and the shared resources. The second theme resources include the second resources and the shared resources.

In some embodiments, the shared resources include the shared resource files and the shared configuration information. The shared resource files include at least one of shared font files and shared icons. The shared configuration information includes at least one of font sizes, font colors, and background colors.

In some embodiments, the first system is configured to display the watch face interface, and the second system is configured to display the another user interface other than the watch face interface. The first theme resources include the resource files and configuration information corresponding to the watch face interface. The second theme resources include the resource files and configuration information corresponding to the another user interface.

In some embodiments, the second system module 1102 is further configured to: in response to receiving the successful message of synchronization sent from the first system module 1101, perform the theme switch based on the theme resource parsing result; and in response to receiving the failed message of synchronization sent from the first system module 1101, or in response to no reception of the feedback message of the synchronization result sent from the first system module 1101 within the target time period, terminate the theme switch.

In some embodiments, the system power consumption of the second system is greater than that of the first system. The second system module 1102 is further configured to: display the theme preview interface; and in response to the triggering operation on the theme switch control in the theme preview interface, download the theme resource package from the server.

In some embodiments, the system power consumption of the second system is less than that of the first system. The electronic device establishes the data connection with an external device through the second system. The second system module 1102 is further configured to: receive the theme resource package transmitted from the external device; and in response to the first system module 1101 being in the sleep state, awake the first system module 1101.

In some embodiments, the first system module 1101 is configured to: in response to the theme switch operation, send the theme switch instruction to the second system module 1102. The second system module 1102 is configured to perform the theme switch based on the theme switch instruction. The first system module 1101 is further configured to perform the theme switch based on the theme switch operation. After the theme switch, the theme style of the first system is the same as that of the second system.

In some embodiments, the theme switch instruction includes the target theme identifier for representing the target theme. The first system and the second system store the correspondence relation between the theme identifier and the theme resource. The second system module 1102 is configured to: obtain, based on the target theme identifier, the second target theme resource corresponding to the target theme, wherein the second target theme resource includes the theme resource required for the second system to switch to and display the target theme; and switch, based on the second target theme resource, the current theme to the target theme. The first system module 1101 is configured to: obtain the first target theme resource corresponding to the target theme, wherein the first target theme resource includes the theme resource required for the first system to switch to and display the target theme; and switch, based on the first target theme resource, the current theme to the target theme.

In some embodiments, the interface displayed by the first system includes the watch face interface. The first system module 1101 is configured to: in response to the sliding operation for switching on the watch face, send the theme switch instruction to the second system module 1102. The sliding operation for switching is configured to switch the watch face interface.

In some embodiments, the first system module 1101 is further configured to: in response to the first theme deletion operation, delete the theme resource, and send the theme deletion instruction to the second system module 1102. The second system module 1102 is configured to delete the theme resource based on the theme deletion instruction.

In some embodiments, the second system module 1102 is configured to: in response to the second theme deletion operation, delete the theme resource; and, send the theme deletion instruction to the first system module 1101. The first system module 1101 is configured to delete the theme resource based on the theme deletion instruction.

In summary, in some embodiments of the present disclosure, for the electronic device supporting dual systems, the theme resource package is parsed by the second system, and the theme resource parsing result including the theme resources of both the first system and the second system are obtained. The second system may further synchronize the theme resources to the first system based on the theme resource parsing result, so as to keep the theme switch between the first system and the second system synchronized. In this way, the consistency between the theme styles of the dual systems after the theme switch is ensured, thereby avoiding the problem of inconsistency in the theme styles of dual systems due to merely switching the theme of a single system of the dual systems.

As illustrated in FIG. 12, FIG. 12 is a structural block diagram of an electronic device according to an embodiment of the present disclosure. The electronic device of the present disclosure may include one or more of the following components: a processor 1210 and a memory 1220.

In some embodiments, the processor 1210 at least includes a first processor 1211 and a second processor 1212. The first processor 1211 is configured to run the first system. The second processor 1212 is configured to run the second system. The power consumption of the first processor 1211 is less than that of the second processor 1212. The performance of the first processor 1211 is inferior to that of the second processor 1212. The processor 1210 may be connected to various portions within the entire electronic device via a variety of interfaces and wiring, perform various functions of the electronic device and process data by running or executing instructions, programs, code sets, or instruction sets stored in the memory 1220, as well as by calling up data stored in the memory 1220. In some embodiments, the processor 1210 may be implemented in at least one hardware form of a digital signal processing (DSP), a field-programmable gate array (FPGA), and a programmable logic array (PLA). One or a combination of multiple ones selected from the group consisting of a central processing unit (CPU), a graphics processing unit (GPU), a neural-network processing unit (NPU), and a modem, etc., may be integrated into the processor 1210. The CPU mainly deals with an operating system, the user interfaces and the applications, etc. The GPU is configured for rendering and drawing contents that are to be displayed on the touch display screen. The NPU is configured to implement artificial intelligence (AI) functions. The modem is configured to deal with the wireless communication. The above-mentioned modem may also be realized via a separate chip without being integrated into the processor 1210.

The memory 1220 may include a random-access memory (RAM), or may include a read-only memory (ROM). In some embodiments, the memory 1220 includes a non-transitory computer-readable storage medium. The memory 1220 may be configured to store instructions, programs, codes, code sets or instruction sets. The memory 1220 may include a program storage area and a data storage area. The program storage area may store instructions for implementing the operating system, instructions for at least one function (e.g., a touch control function, a sound play function, an image play function, etc.), or instructions for implementing each of the method embodiments described below, etc. The data storage area may store data (e.g., audio data, a phone book), etc. The data is created in accordance with the usage of the electronic device.

In some embodiments, the electronic device may further include a communication component 1230 and a display component 1240. The communication component 1230 may be a Bluetooth component, a Wi-Fi component, an NFC component, etc. The communication component 1230 is configured to perform communication with an external device (a server or another terminal device) via a wired or wireless network. The display component 1240 is configured to perform a graphical user interface presentation, and/or, to receive a user interaction operation.

In addition, those skilled in the art would appreciate that, the structure of the electronic device illustrated in the above-mentioned accompanying drawings does not constitute a limitation on the electronic device. The electronic device may include more or fewer components than illustrated, or a combination of certain components, or a different arrangement of components. For example, the electronic device may also include components such as radio frequency circuits, input units, sensors, audio circuits, speakers, microphones, power supplies etc., which will not be repeated herein.

In some embodiments, a non-transitory computer-readable storage medium is further provided. The storage medium is configured to store at least one instruction. The at least one instruction is configured to be executed by the processor to implement the theme switch method of the above-mentioned embodiments.

In some embodiments, a computer program product may be further provided. The computer program product includes a computer instruction. The computer instruction is stored in the computer-readable storage medium. The processor of the electronic device is configured to read the computer instruction from the computer-readable storage medium. The processor is configured to execute the computer instruction, to enable the electronic device to perform the theme switch method provided in the above-mentioned embodiments.

Those skilled in the art should appreciate that, in the above-mentioned one or more examples, the functions described may be implemented by hardware, software, firmware, or any combination thereof. When implemented by the software, the functions may be stored in a computer-readable medium or transmitted as one or more instructions or codes on a computer-readable medium. The computer-readable medium may include a computer storage medium and a communication medium. The communication medium includes any medium that facilitates the transmission of the computer program from one location to another. The storage medium may be any available medium to which a general-purpose computer or a dedicated computer has access.

The above-mentioned are merely optional embodiments of the present disclosure, and are not used to limit the present disclosure. Any modification, equivalent substitution, improvement, etc. made within the spirit and principles of the present disclosure shall be included in the protection scope of the present disclosure.

What is claimed is:

1. A theme switch method, wherein the method is performed by an electronic device, the electronic device is configured to support running of a first system and a second system; and
the method comprises:
parsing, by the second system, a theme resource package, and obtaining a theme resource parsing result, wherein the theme resource parsing result comprises theme resources for the first system and the second system;
synchronizing, by the second system, the theme resources to the first system based on the theme resource parsing result;
performing, by the first system, theme switch based on synchronized theme resources; and
performing, by the second system, the theme switch based on the theme resource parsing result, wherein after the theme switch, a theme style of the first system is the same as that of the second system.

2. The method as claimed in claim 1, wherein
the theme resource parsing result comprises first theme resources and second theme resources;
the first theme resources comprise theme resources required for the first system to perform the theme switch, and the second theme resources comprise theme resources required for the second system to perform the theme switch;
the synchronizing, by the second system, the theme resources to the first system based on the theme resource parsing result comprises:
synchronizing, by the second system, the first theme resources to the first system;
the performing, by the second system, the theme switch based on the theme resource parsing result comprises:
performing, by the second system, the theme switch based on the second theme resources.

3. The method as claimed in claim 2, wherein
the theme resource parsing result comprises first resources, second resources and shared resources;
the first resources are theme resources unique for the first system, the second resources are theme resources unique for the second system, and the shared resources are theme resources shared by the first system and the second system;
the first theme resources comprise the first resources and the shared resources, and the second theme resources comprise the second resources and the shared resources.

4. The method as claimed in claim 3, wherein
the shared resources comprise shared resource files and shared configuration information;
the shared resource files comprise at least one selected from a group consisting of a shared font files and a shared icons; and
the shared configuration information comprises at least one selected from a group consisting of a font sizes, a font colors and a background colors.

5. The method as claimed in claim 2, wherein
the first system is configured to display a watch face interface, and the second system is configured to display a watch face interface and/or another user interface other than the watch face interface;
the first theme resources comprise resource files and configuration information corresponding to the watch face interface; and
the second theme resources comprise resource files and the configuration information corresponding to the watch face interface and/or the another user interface.

6. The method as claimed in claim 1, wherein
the performing, by the second system, the theme switch based on the theme resource parsing result comprises:
in response to receiving a successful message of synchronization sent from the first system, performing, by the second system, the theme switch based on the theme resource parsing result;
the method further comprises:
in response to receiving a failed message of synchronization sent from the first system, or, in response to no reception of a feedback message of a synchronization result sent from the first system within a target time period, terminating, by the second system, the theme switch.

7. The method as claimed in claim 1, wherein
a system power consumption of the second system is greater than that of the first system,
the method further comprises:
displaying, by the second system, a theme preview interface; and
in response to a triggering operation on a theme switch control in the theme preview interface, downloading, by the second system, the theme resource package from a server.

8. The method as claimed in claim 1, wherein
a system power consumption of the second system is less than that of the first system, and the electronic device is configured to establish a data connection with an external device through the second system;
the method further comprises:
receiving, by the second system, the theme resource package transmitted from the external device; and
in response to the first system being in a sleep state, awaking, by the second system, the first system.

9. The method as claimed in claim 1, further comprising:
sending, by the first system, a theme switch instruction to the second system in response to a theme switch operation;
performing, by the second system, the theme switch based on the theme switch instruction; and
performing, by the first system, the theme switch based on the theme switch operation,
wherein after the theme switch, the theme style of the first system is the same as that of the second system.

10. The method as claimed in claim 9, wherein
the theme switch instruction comprises a target theme identifier for representing a target theme, and the first system and the second system store a correspondence relation between theme identifiers and the theme resources;
the performing, by the second system, the theme switch based on the theme switch instruction comprises:
obtaining, by the second system, a second target theme resource corresponding to the target theme based on the target theme identifier, wherein the second target theme resource comprises the theme resource required for the second system to switch to and display the target theme;
switching, by the second system, a current theme to the target theme based on the second target theme resource;
the performing, by the first system, the theme switch based on the theme switch operation comprises:
obtaining, by the first system, a first target theme resource corresponding to the target theme, wherein the first target theme resource comprises the theme resource required for the first system to switch to and display the target theme; and
switching, by the first system, the current theme to the target theme based on the first target theme resource.

11. The method as claimed in claim 9, wherein
an interface displayed by the first system comprises a watch face interface;
the sending by the first system the theme switch instruction to the second system in response to the theme switch operation, comprises:
in response to a sliding operation for switching on a watch face, sending, by the first system, the theme switch instruction to the second system, wherein the sliding operation for switching is configured to switch the watch face interface.

12. The method as claimed in claim 1, further comprising:
in response to a first theme deletion operation, deleting, by the first system, a theme resource and sending a theme deletion instruction to the second system; and deleting, by the second system, the theme resource based on the theme deletion instruction; or
in response to a second theme deletion operation, deleting, by the second system, a theme resource and sending the theme deletion instruction to the first system; and deleting, by the first system, the theme resource based on the theme deletion instruction.

13. An electronic device comprising a processor and a memory, and configured to support running of a first system and a second system, wherein
the memory is configured to store at least one instruction; and
the at least one instruction is configured to be executed by the processor to implement a theme switch method,
wherein the method comprises:
parsing, by the second system, a theme resource package, and obtaining a theme resource parsing result, wherein the theme resource parsing result comprises theme resources for the first system and the second system;
synchronizing, by the second system, the theme resources to the first system based on the theme resource parsing result;
performing, by the first system, theme switch based on synchronized theme resources; and
performing, by the second system, the theme switch based on the theme resource parsing result, wherein after the theme switch, a theme style of the first system is the same as that of the second system.

14. The electronic device as claimed in claim 13, wherein
the theme resource parsing result comprises first theme resources and second theme resources;
the first theme resources comprise theme resources required for the first system to perform the theme switch, and the second theme resources comprise theme resources required for the second system to perform the theme switch;
the synchronizing, by the second system, the theme resources to the first system based on the theme resource parsing result comprises:
synchronizing, by the second system, the first theme resources to the first system;
the performing, by the second system, the theme switch based on the theme resource parsing result comprises:
performing, by the second system, the theme switch based on the second theme resources.

15. The electronic device as claimed in claim 14, wherein
the theme resource parsing result comprises first resources, second resources and shared resources;
the first resources are theme resources unique for the first system, the second resources are theme resources unique for the second system, and the shared resources are theme resources shared by the first system and the second system;
the first theme resources comprise the first resources and the shared resources, and the second theme resources comprise the second resources and the shared resources.

16. The electronic device as claimed in claim 14, wherein
the first system is configured to display a watch face interface, and the second system is configured to display a watch face interface and/or another user interface other than the watch face interface;
the first theme resources comprise resource files and configuration information corresponding to the watch face interface; and
the second theme resources comprise resource files and the configuration information corresponding to the watch face interface and/or the another user interface.

17. The electronic device as claimed in claim 13, wherein
the performing, by the second system, the theme switch based on the theme resource parsing result comprises:
in response to receiving a successful message of synchronization sent from the first system, performing, by the second system, the theme switch based on the theme resource parsing result;
the method further comprises:
in response to receiving a failed message of synchronization sent from the first system, or, in response to no reception of a feedback message of a synchronization result sent from the first system within a target time period, terminating, by the second system, the theme switch.

18. The electronic device as claimed in claim 13, wherein
a system power consumption of the second system is greater than that of the first system,
the method further comprises:
displaying, by the second system, a theme preview interface; and
in response to a triggering operation on a theme switch control in the theme preview interface, downloading, by the second system, the theme resource package from a server.

19. The electronic device as claimed in claim 13, wherein
the method further comprises:
sending, by the first system, a theme switch instruction to the second system in response to a theme switch operation;
performing, by the second system, the theme switch based on the theme switch instruction; and
performing, by the first system, the theme switch based on the theme switch operation,
wherein after the theme switch, the theme style of the first system is the same as that of the second system.

20. A non-transitory computer-readable storage medium storing at least one instruction, wherein
the at least one instruction is configured to be executed by a processor to implement a theme switch method, the method is performed by an electronic device, the electronic device is configured to support running of a first system and a second system, and the method comprises:
parsing, by the second system, a theme resource package, and obtaining a theme resource parsing result, wherein the theme resource parsing result comprises theme resources for the first system and the second system;
synchronizing, by the second system, the theme resources to the first system based on the theme resource parsing result;
performing, by the first system, theme switch based on synchronized theme resources; and
performing, by the second system, the theme switch based on the theme resource parsing result, wherein after the theme switch, a theme style of the first system is the same as that of the second system.
